(19) United States
(12) Patent Application Publication
(10) Pub. No.: US 2023/0077456 A1
(43) Pub. Date: Mar. 16, 2023

(54) UPPER ARM CUFF CRUTCHES

(71) Applicant: Aligned As Designed, LLC, Los Angeles, CA (US)

(72) Inventor: Linda Smith Swerdlow, Los Angeles, CA (US)

(21) Appl. No.: 17/931,785

(22) Filed: Sep. 13, 2022

Related U.S. Application Data
(60) Provisional application No. 63/243,646, filed on Sep. 13, 2021.

(51) Int. Cl. A61H 3/02

(52) U.S. Cl. CPC A61H 3/0288; A61H 2201/1635; A61H 2003/007

(57) ABSTRACT

An ambulatory aid, such as one or more crutches, including a height adjustable shaft, a handle portion extending from a middle portion of the shaft, a foot portion, and an extension portion termination with a closed loop cuff for securing to the upper arm of a subject. The height adjustable shaft of the crutch can be adjustable at a top end, middle, a bottom end, or any combination thereof. The top of the cane shaft is aligned at a more posterior angle then the bottom of the shaft. The handle of the crutch is elongated and extends horizontally and lateral to the height adjustable shaft. In a particular embodiment, a posterior portion of the handle is longer, and optionally larger in surface area than an anterior portion of the handle such that the handle is configured so that when the person's hand is gripping the handle, the handle will be offset over the shaft.

### CROSS-REFERENCE TO RELATED APPLICATIONS

The present application claims the benefit of U.S. Provisional Application Ser. No. 63/243,646, filed Sep. 13, 2021, which is incorporated by reference herein in its entirety. The present application also incorporates by reference in their entireties U.S. Pat. No. 10,188,183, filed Sep. 22, 2017, and U.S. Pat. No. 11,020,308, filed Nov. 8, 2017.

### TECHNICAL FIELD

The present disclosure relates generally to mobility devices, and more specifically to crutches, or walking aids.

### BACKGROUND

Crutches are a tool commonly used for medical conditions or injuries that require a patient to reduce or eliminate weight on a lower extremity. Traditional crutches match the height of the patient, to rest directly under their underarm allowing them to weight-bear and shift pressure off of the injured extremity. In general, crutches have a shaft or straight portion that terminates in a tip that makes contract with the ground (usually round in nature), and a handgrip between the two ends. Crutches allow a patient to transfer the weight that would have ordinarily been placed on the injured extremity, to the foundation of the crutch.

There are several categories of crutches that exist today, which may include, underarm, forearm, platform, or knee support crutches. The most commonly used crutch, is an underarm or axillaries crutch and are typically used by persons having a temporary disability or injury. Underarm crutches ordinarily have a pad that rests against armpit, and a handle along the shaft of the crutch that a user grips for stabilization. Underarm crutches are used for short periods of time (or as temporarily as possible) because they tend to be uncomfortable, cumbersome, and difficult to use for users. Often, the discomfort caused by the pad under a user's arm, the relative strength required to hold the handles, the advanced coordination to maintain grip on the crutch while moving, and lack of hands-free operation makes an underarm crutch a less than ideal.

Traditional forearm crutches, which include a cuff positioned to couple to the lower arm of a user right below the elbow, restricts the ability of the user to bend or extend their elbow. This increases instability when traversing, for example, stairs and the like. Traditional crutches such as these may cause additional injuries to the patients' nerves, arm, elbow, or wrist resulting from the stress of the weight, and the unconventional grip holdings required for traditional use. Further, traditional crutches are rarely perfectly sized to a subject's height or proportions, which alters their gait and can cause alignment issues. Traditional crutches also place patients in a relatively unstable stance. If held at an improper angle, or if a patients takes too large of a step with the crutch, they may lose balance and further injure themselves. The bottom portion of the crutch that makes contact with the ground is often small, and does very little to provide a more stable base for the patient. If the bottom of the crutch meets the ground at an angle, it may slip, again causing the patient to lose balance and fall.

Therefore, there remains a need for a crutch or walking with enhanced stability and comfort for the patient.

### SUMMARY

In embodiments, one or more upper arm crutches may include a height adjustable shaft, a handle portion extending from a middle portion of the shaft, a foot portion, and an extension portion termination with a closed loop cuff for securing to the upper arm of a subject. The foot portion can be, for example, a foot member as described in U.S. Pat. No. 10,188,183, entitled “Ambulatory Aid” and filed Sep. 22, 2017, or as described in U.S. Pat. No. 11,020,308, entitled “Ambulatory Aid” and filed Nov. 8, 2017, both of which are incorporated herein by reference in their entireties.

The closed loop cuff positioned for securing to the upper arm of the subject allows for enhanced mobility and comfort. For example, the position of the cuff allows for the elbow to bend, thereby increasing mobility and stability up and down stairs, for example. The closed loop cuff also allows the user to use the crutch hands free, such as to hold an object, without the cuffs falling away from the user's arm. The closed loop cuff also allows the user to easily slide their arms into the closed loop cuff. The closed loop cuff further incorporates a breakaway feature for safety.

The height adjustable shaft may comprise an elongate hollow, partially filled, or filled tube. The crutch shaft may have a cross-section that is substantially circular, oval, square, rectangular, triangular, or any of a variety of suitable shapes. The crutch shaft can be formed of lightweight aluminum, carbon fiber, plastic, or any of a variety of materials or combinations thereof, which are preferably light weight yet durable.

In embodiments, the portion of the height adjustable shaft between the closed loop cuff and the handle portion may be at a slight angle to produce a more natural fit, and enable a natural gait for the subject. The angle may run in line with the upper arm of the subject (between the elbow and ending before the shoulder).

In embodiments, the height adjustable shaft is adjustable at a top end, middle, a bottom end, or any combination thereof In a particular embodiment, in which the height adjustable shaft is adjustable at both the top and bottom ends of the shaft, this configuration allows the user to maintain postural stability and vertical alignment while adjusting the crutch's height before sitting or standing, and before ascending or after descending a flight of stairs.

In embodiments, the foot portion of the crutch is elongated and extends anterior and posterior to the crutch shaft. In a particular embodiment, an anterior portion of the foot portion is longer than the posterior portion. The bottom and sides of the foot portion are tubular or arcuate in shape. In other words, a surface contacting portion of the foot portion is non-planar, but is instead curved or arcuate, allowing the foot portion to roll onto and over a surface during the gait cycle, thereby mimicking the heel to toe motion of the normal gait cycle. In one embodiment, the crutch foot is formed of an interior and a tubular rubber exterior, optionally with one or more ridges to provide friction and additional stability.

In embodiments, the height adjustable shaft may terminate with a closed loop cuff for securing to the upper arm of a subject. The closed loop cuff may be made of any suitable material including but not limited to plastic, or another material that is lightweight and flexible.

The closed loop cuff may be adjustable to securely fit the subject's upper arm. In another embodiment, the closed loop cuff may be removable from the height adjustable shaft of the crutch, allowing for different sized cuffs to be attached, rather that size adjustable. The closed loop cuff can also include a breakaway safety feature which allows the cuff to open up and free the arm, such as in the event of a fall.

The above summary is not intended to describe each illustrated embodiment or every implementation of the subject matter hereof. The figures and the detailed description that follow more particularly exemplify various embodiments.

### BRIEF DESCRIPTION OF THE DRAWINGS

Subject matter hereof may be more completely understood in consideration of the following detailed description of various embodiments in connection with the accompanying figures, in which:

FIG. 1 is a perspective view of a set of crutches according to one embodiment.

FIG. 2 is a perspective view the top half of a set of crutches according to one embodiment.

FIG. 3 is a perspective view of a closed loop cuff according to one embodiment.

FIG. 4 is a perspective view of a set of closed loop cuffs according to one embodiment.

FIG. 5 is a perspective view of a foot portion of a crutch according to one embodiment.

While various embodiments are amenable to various modifications and alternative forms, specifics thereof have been shown by way of example in the drawings and will be described in detail. It should be understood, however, that the intention is not to limit the claimed disclosures to the particular embodiments described. On the contrary, the intention is to cover all modifications, equivalents, and alternatives falling within the spirit and scope of the subject matter as defined by the claims.

### DETAILED DESCRIPTION OF THE DRAWINGS

Embodiments described herein generally pertain to ambulatory aids, or crutches. Further, embodiments pertain to one or more crutches that may have a closed loop cuff.

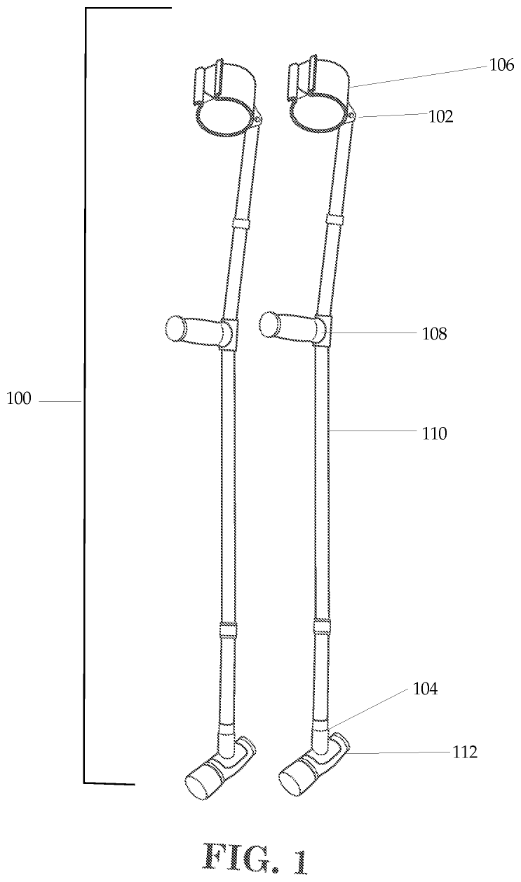

Referring to FIG. 1, according to an embodiment of the present disclosure, a crutch 100 generally comprises an elongate shaft 110 extending between a first end 102 and a second end 104, a handle 108 coupled to first end 102, and a foot piece 112 coupled to second end 104. Shaft 110 may comprise an elongate hollow, partially filled, or filled tube. Shaft 110 may be formed of lightweight aluminum, carbon fiber, plastic, or any of a variety of materials or combinations thereof, which are preferably light weight yet durable.

In embodiments, shaft 110 may be height adjustable proximate first end 102, at a middle portion, proximate second end 104, or any combination thereof. Shaft 110 can be height adjustable be any suitable means known to one of ordinary skill in the art. Because the height adjustment of the shaft 110 may be completed at the first end 102, a middle portion, or a second end 104, the height may be manipulated to facilitate a subject sitting down, standing up, going up or down stairs, or any other movement or action that may require a height adjustment, while receiving support.

In embodiments, handle 108 extends horizontally and anterior to the shaft 110. Handle 100 mirrors the extension of the foot piece 112, though foot piece 112 may be coupled to the second end 104. Handle 108 may be made of any suitable material that allows for grip and comfort, including variations of plastic, rubber, or foam. Handle 108 may be different lengths or sizes based on the measurements of the users hands.

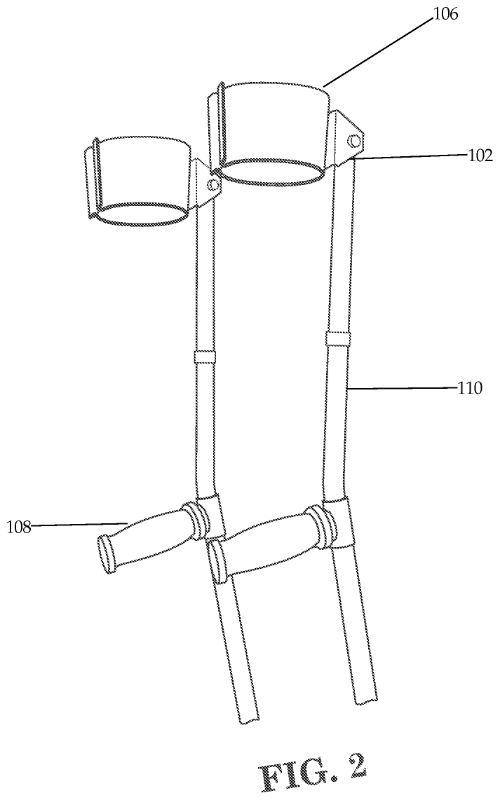

Referring now to FIG. 2, a top half of a crutch according to one embodiment. The closed loop cuff 106 may be coupled to the first end 102. Between the closed loop cuff 106 and the handle 108, the shaft 110 may extend at an angle relative to being straight. The slight angle may produce a more natural fit against a subject's upper arm. The handle may extend from a middle portion of the shaft 110. Each portion of the shaft 110 may be height adjustable, and may move other pieces (such as the closed loop cuff 106, the handle 108, or the foot piece 112), relative to their original positions.

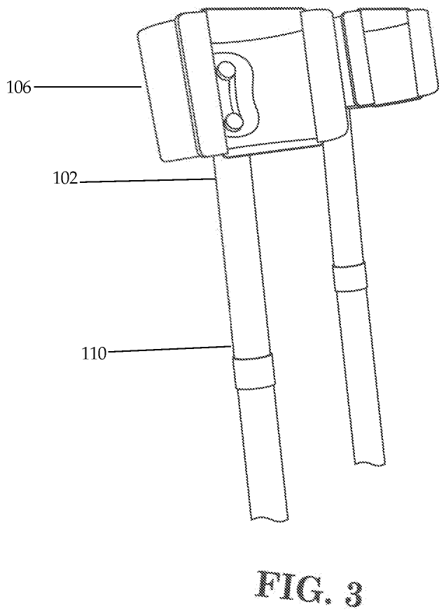

Referring now to FIG. 3, a perspective view of a closed loop cuff 106 according to one embodiment. The closed loop cuff 106 may be coupled to the first end 102 of the crutch 100. The first end 102 of shaft 110 may be reversibly coupled to the closed loop cuff 106 using screws or any other suitable means. The closed loop cuff 106 may be fixed in size and interchangeable to fit the arm of a subject. In another embodiment, the closed loop cuff 106 may be adjustable in size, allowing a subject to change the size to best fit the circumference of their upper arm. In embodiments, the closed loop cuff 106 includes a breakaway features to allow the arm to be freed in the event of a fall or other adverse event.

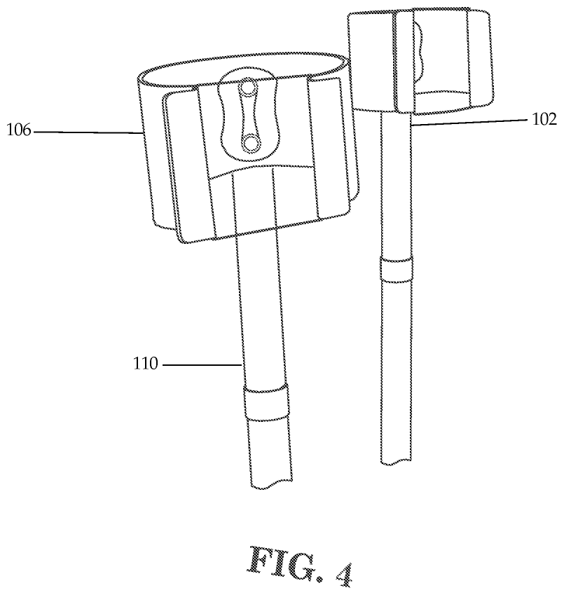

Referring now to FIG. 4, a perspective view of a closed loop cuff 106 according to one embodiment. The closed loop cuff 106 may have a ridge or lip on either side of the closed loop cuff 106. The posterior side of the closed loop cuff 106 may have a small, straight piece to secure the arm of the subject in the cuff. The user begins by sliding their hand through the opening of the closed loop cuff 106, until the closed loop cuff 106 is secured around their upper arm (usually around a bicep, or between the bicep and shoulder). Once the closed loop cuff 106 is secured around a user's upper arm, they may grasp the handle 108. Users may require only one crutch, or a pair of crutches may be used.

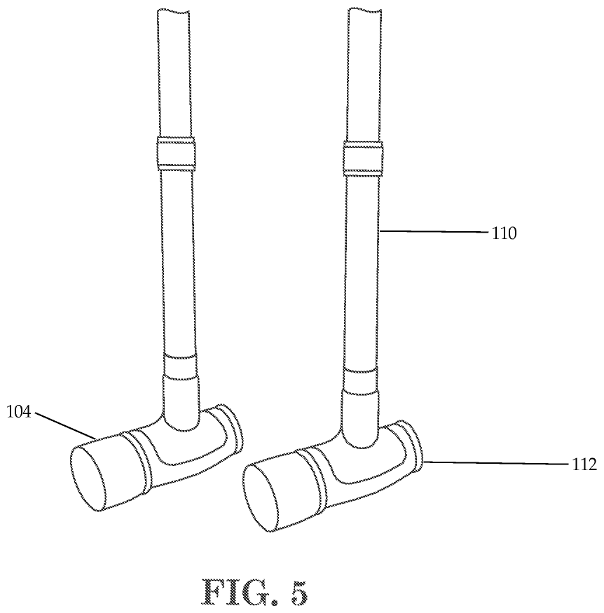

Referring now to FIG. 5, a perspective view of a foot piece 112 according to one embodiment. Foot piece 112 is typically circular in cross section, and extends radially from shaft 110 about a circumference of shaft 110. Shaft 12 extends substantially vertical from the handle 108 to the foot piece 112. As discussed above, this causes, during the swing phase of the gait cycle, the traditional cane shaft to become more horizontal than vertical and only the small anterior edge of the cane's foot maintains the body's stability.

In one embodiment, foot piece 112 is formed of an interior material, such as an open-cell foam, closed-cell foam, plastic, or rubber material, and a tubular rubber or silicon exterior cover, optionally with one or more ridges formed thereon, to provide friction and additional stability.

In operation, the crutch 100 may have several components, including but not limited to: a closed loop cuff 106 for a subject to place their upper arm in, a shaft 110 that extends from a first end 102 to a second end 104, a handle 108, and a foot piece 112. The crutch 100 may come to a subject already assembled, or in separate pieces. The closed loop cuff 106, the handle 108, and the foot piece 112 may come in various sizes to suit a subject's needs.

In use, and as described above, the crutch according to the embodiments described herein give the user a mechanical advantage by creating a more natural range of motion. The closed loop cuff 106 is secured around the upper arm and is closed at the top and bottom of the cuff. The closed loop cuff 106 is positioned above the elbow, allowing the user to flex or bend the elbow. A user may slide their arm through the closed loop cuff 106, and for example, push an elevator button or hold something in their hand without the cuff falling and dropping the crutch 100. Traditional forearm crutches may decrease a user's range of motion. The height and placement of the top of the crutch 100 maintains center of gravity within the body's base of support as well as the vertical stability of the body with the head aligned and centered over and between the shoulders. The vertical alignment and stability of the body is maintained by the upper arm cuff which creates better vertical stability, with the use of the foot piece 112.

In embodiments, securing a user's upper arm through the closed loop cuff 106 may create increased stability, when compared to traditional under-arm crutches or traditional braced crutches which are coupled to a user's elbow or lower arm right below the elbow. Further, the weight distribution through the upper body prevents injuries or discomfort from carrying all of the bodyweight of a user on the underarm portion of a traditional crutch.

In embodiments, as opposed to traditional crutches, an entire front or anterior portion of the crutches foot, and not just the front edge, maintains contact with the ground during the swing phase of the gait cycle such that the body maintains a shorter distance between the hip joint's line of axis and the contralateral hand when standing and during locomotion when using this crutch.

Various embodiments of systems, devices, and methods have been described herein. These embodiments are given only by way of example and are not intended to limit the scope of the claimed disclosures. It should be appreciated, moreover, that the various features of the embodiments that have been described may be combined in various ways to produce numerous additional embodiments. Moreover, while various materials, dimensions, shapes, configurations and locations, etc. have been described for use with disclosed embodiments, others besides those disclosed may be utilized without exceeding the scope of the claimed disclosures.

Persons of ordinary skill in the relevant arts will recognize that the subject matter hereof may comprise fewer features than illustrated in any individual embodiment described above. The embodiments described herein are not meant to be an exhaustive presentation of the ways in which the various features of the subject matter hereof may be combined. Accordingly, the embodiments are not mutually exclusive combinations of features; rather, the various embodiments can comprise a combination of different individual features selected from different individual embodiments, as understood by persons of ordinary skill in the art. Moreover, elements described with respect to one embodiment can be implemented in other embodiments even when not described in such embodiments unless otherwise noted.

Although a dependent claim may refer in the claims to a specific combination with one or more other claims, other embodiments can also include a combination of the dependent claim with the subject matter of each other dependent claim or a combination of one or more features with other dependent or independent claims. Such combinations are proposed herein unless it is stated that a specific combination is not intended.

Any incorporation by reference of documents above is limited such that no subject matter is incorporated that is contrary to the explicit disclosure herein. Any incorporation by reference of documents above is further limited such that no claims included in the documents are incorporated by reference herein. Any incorporation by reference of documents above is yet further limited such that any definitions provided in the documents are not incorporated by reference herein unless expressly included herein.

For purposes of interpreting the claims, it is expressly intended that the provisions of 35 U.S.C. § 112(f) are not to be invoked unless the specific terms “means for” or “step for” are recited in a claim.

1. A crutch comprising:
a shaft extending between a first end and a second end;
a handle coupled to the shaft between the first end and the second end;
a foot piece coupled to a second end of the shaft;
a closed loop cuff coupled to the first end of the shaft, wherein the closed loop cuff is configured to be positioned around a subject's upper arm above an elbow of the subject.

2. The crutch of claim 1, wherein the closed loop cuff is adjustable in size.

3. The crutch of claim 1, wherein the shaft is adjustable in at least two positions on the shaft.

4. The crutch of claim 1, the shaft is adjustable in at least three positions on the shaft.

5. The crutch of claim 1, wherein the shaft is not linear, and wherein a first portion of the shaft extends at an angle between the handle and the footpiece relative to a second portion of the shaft between the handle and the closed loop cuff.

6. The crutch of claim 5, wherein the second end of the shaft is coupled to the foot piece such that an anterior portion of the foot piece extends from the shaft at a length greater than a posterior portion of the foot portion such that the first portion of the shaft extends at an angle when measured from a horizontal surface.

7. The crutch of claim 1, wherein the foot piece is composed of a material selected from the group consisting of: an open-cell foam, closed-cell foam, plastic, or rubber material.

8. The crutch of claim 1, wherein the foot piece includes a tubular rubber or silicon exterior cover, with one or more ridges formed thereon.

9. The crutch of claim 1, wherein the closed loop cuff includes a breakaway feature configured to automatically open the closed loop if the subject experiences a fall.

10. The crutch of claim 1, wherein the closed loop cuff configured to be coupled to the subject's upper arm above the elbow such that the elbow is able to bend.

11. A crutch comprising:
a first shaft extending between a first end and a second end;
a second shaft coupled to the second end of the first shaft at an angle, and extending between the second end and a third end;
a handle coupled to the second end of the first shaft; and
a closed loop cuff coupled to the first end of the first shaft, wherein the closed loop cuff is configured to be positioned around a subject's upper arm above an elbow of the subject.

12. The crutch of claim 11, further comprising:
a foot piece coupled to the third end of the second shaft.

13. The crutch of claim 12, wherein the third end of the second shaft is coupled to the foot piece such that an anterior portion of the foot piece extends from the shaft at a length greater than a posterior portion of the foot portion such that the second shaft extends at an angle when measured from a horizontal surface.

14. The crutch of claim 11, wherein the closed loop cuff is adjustable in size.

15. The crutch of claim 11, wherein the closed loop cuff includes a breakaway feature configured to automatically open the closed loop if the subject experiences a fall.

16. The crutch of claim 11, wherein the first shaft is adjustable in at least one position on the first shaft.

17. The crutch of claim 11, wherein the second shaft is adjustable in at least one on the second shaft.
